(19) United States
(12) Patent Application Publication
(10) Pub. No.: US 2003/0223371 A1
(43) Pub. Date: Dec. 4, 2003

(54) Device and method for controlling profiles, in particular data flows, in a communications network

(75) Inventors: Emmanuel Marilly, Antony (FR); Stephane Betge-Brezetz, Paris (FR); Olivier Martinot, Draveil (FR); Gerard Delegue, Cachan (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/449,507

(22) Filed: Jun. 2, 2003

(30) Foreign Application Priority Data
Jun. 3, 2002 (FR) 02 06 791

(51) Int. Cl. H04L 1/00

(52) U.S. Cl. 370/235; 370/412

(57) ABSTRACT

A device for controlling primary data in a communications network equipped with measuring means (2) delivering primary information representing primary data comprises a memory (4) in which there are stored secondary data defining models representing primary information, as well as control means (3) arranged to compare the primary information delivered with at least one of the models, so as to deliver a message representing a level of correlation between this primary information and the model chosen.

The invention concerns the field of communications between terminals in a network, and more particularly that of controlling the data exchanged by such terminals.

Because of the continuous increase in data exchanged in communications networks and the number and variety of the services offered to customers using the networks and their equipment, the number of measurable data and the number of measurements necessary for managing the traffic and managing the service levels are continually increasing. The network manager, who is responsible for resolving the traffic problems and providing reports intended for the operator and his customers, must therefore more and more analyse (primary) information concerning the data exchanged.

This problem is increased further when the operator of the network makes with his customers service level agreements which include technical parts defined by service level specifications.

A few tools have been proposed to facilitate this analysis, such as for example Proviso from the company Quallaby, or Infovista. However, these tools generally perform only fairly simple analyses, such as for example

controlling of the bandwidth used (an alarm being delivered in the event of a limit threshold being passed). One example of such a state of the art is for example described in European patent application EP1065827,

or the comparison to order of a mean curve relating to old (primary) information with a mean curve relating to new (primary) information.

More sophisticated analyses almost always require action from the manager. This is particularly the case with controlling the changes in daily, weekly or monthly traffic curves, essential to the management of the network, and particularly to the anticipation of traffic overloads.

At the present time therefore there exists no control tool for analysing in an automated fashion the (primary) information concerning the (primary) data exchanged between terminals, whether it is a case of traffic information or service information, such as the service levels or the service level indicators.

The aim of the invention is therefore to remedy the aforementioned drawback.

To this end it proposes a device for controlling primary data in a communications network equipped with measuring means delivering primary information representing primary data, such as for example the bandwidth used.

This device is characterised by the fact that it comprises on the one hand a memory (or database) in which there are stored secondary data which define models representing primary information, and on the other hand control means arranged to compare the primary information delivered by the measuring means to at least one of the models so as to deliver a message representing a correlation (or identification) level between this primary information and the model chosen.

“Correlation (or identification) level” means both a close relationship (or similarity) or an absence of relationship (or similarity). Moreover, “model” means here an n-dimensional curve or profile, n being at least 1. In addition, the word “model” must here be taken in the “automatic” sense, that is to say of an equation or method for predicting or describing the behaviour of an (identification) system. A curve constitutes the simplest model since it comprises a set of points (without determination of a mathematical model). Consequently it is possible to use a mathematical description for describing a model.

Preferentially, the memory stores models representing the change in flows (or behaviours) of primary data, such as for example traffic (or bandwidth used) curves or profiles, on chosen time windows (such as for example a given hour in a day, a given day in a week, a given week in a month, or a given month in a year). Many other network measurements can be taken into account, such as for example losses of packets, delays between packets, jitter or stability, the bandwidth or the stability of the bandwidth. However, it is also possible to take account of other types of parameter, such as for example those resulting from formulae defining for example the stability of the bandwidth or the change in the stability, or the reliability or directionality of a communication, or the like. It is also possible to use extrapolated parameters, such as for example parameter trends.

In one advantageous embodiment, the device can comprise on the one hand processing means intended to receive the primary information and store it in the memory, as it arrives, in correspondence with chosen time windows, and to compare the primary information delivered, associated with a chosen time window, with at least some of the primary information stored, associated with this chosen time window, so as to determine any invariance between the primary information delivered and stored, and on the other hand modelling means capable, in the event of detection of an invariance, of generating a model representing information delivered and storing it in the memory. In this way new models are automatically generated using the history of the primary information received.

“Invariance” means here a behaviour which is repeated in a substantially constant or invariant fashion under substantially identical conditions.

In this case, the processing means are preferentially arranged to extract from the memory certain primary information stored, associated with the same chosen time window, and then to generate secondary information representing this averaged primary information, and to determine any invariance according to at least this secondary information. For example, secondary information defining a curve of mean measurements is generated from curves of measurements previously received.

In a variant or in addition, the processing means can be arranged on the one hand to determine tertiary information representing distributions of the values of certain secondary information (for example a variance), and to compare this tertiary information with first thresholds, so as to determine any invariance in the primary information delivered and stored. However, the invariance can be estimated by other means, such as for example by the calculation of a statistical difference.

Moreover, the models can be generated in various ways. One solution can consist in defining them from all the secondary information (all the secondary information defining the model is then stored in the memory in the form of secondary data). Another solution consists in defining them from a mathematical processing (such as for example a polynomial regression) applied to the secondary information (only the parameters representing the result of the mathematical processing, and defining the model, then being stored in the memory in the form of secondary data).

In order not to overload the memory, the modelling means can compare each new model generated with the models stored so as to store only the models which are actually different from the old ones.

The models are not necessarily generated by the device according to the invention. Some, or even all, may in fact be supplied by an operator, via an interface. They may also be associated with auxiliary information, for example intended to constitute at least part of the message delivered.

The control means can be arranged to extract from the memory, either automatically, for example by recognition of the type of primary information received, or to order, for example from the manager, at least one of the models, in order to determine the difference between at least one of the values defining the primary information and the corresponding value associated with the model extracted, and finally to deliver a message representing the difference thus determined. In this case, the controlling means can be arranged to “constitute” first and second curves (or profiles) from the primary information and the models, and to determine the surface (or area) between these first and second curves, so as to deliver a message representing the value of the surface area, after any comparison with a threshold.

In a variant or in addition, the controlling means can be arranged to determine whether at least some of the primary information delivered has a value contained in a range associated with the value of the corresponding point of the model, and to deliver a message representing the belonging, or not, of the said primary information values to the said intervals.

Finally, the control means can also be arranged to perform predictions of change in primary information by means of an analysis of the variations in difference or differences (or surface area) between the primary information, previously received and processed, and a chosen model.

The device according to the invention can also comprise the memory (or database) containing the models and/or the old primary information.

The invention also relates to a method for controlling primary data in a communications network, consisting in storing in a memory secondary data which define models representing primary information and comparing primary information, representing primary data, with at least one of the models, so as to deliver a message representing a level of correlation between this primary information and the chosen model.

The method according to the invention can comprise many supplementary characteristics which can be taken separately and/or in combination, and in particular:

the models can represent changes in primary data flows on chosen time windows;

it is possible to store in the memory the primary information delivered in correspondence with chosen time windows and then compare the primary information delivered, associated with a chosen time window, with at least some of the primary information stored, associated with this chosen time window, so as to determine any invariance between the primary information delivered and stored and, in the event of detection of invariance, to generate a model representing the primary information and store this model in the memory. In this case, it is possible to extract from the memory certain primary information stored, associated with the same chosen time window, and then to generate secondary information representing this averaged primary information, and to determine any invariance according to at least this secondary information. It is then possible to determine tertiary information representing distributions of the values of certain secondary information (for example a variance), and to compare this tertiary information with first thresholds, so as to determine any invariance in the primary information delivered and stored;

at least some of the models generated may be defined using all the corresponding secondary information, the primary information defining the model then being stored in the memory. In a variant, it is possible to generate at least some of the models from a mathematical processing applied to the corresponding secondary information, the parameters representing the result of the mathematical processing, which define the model, then being stored in the memory;

it is possible to compare each new model generated with the models stored, so as to store a new model only when it is different from the models already stored;

some models may be supplied by an operator;

some models may be associated with ancillary information intended to constitute at least part of the message delivered;

on reception of primary information, it is possible to extract from the memory at least one model chosen, automatically or to order, and then to determine the difference between at least one of the values defining the primary information and the corresponding value associated with the model extracted, and to deliver a message representing the difference. In this case, it is possible to “constitute” first and second curves from the primary information and the models, and to determine the surface area included between these first and second curves, so as to deliver a message representing the value of the surface area;

it is possible to determine whether at least some of the primary information delivered has a value contained in a range associated with the value of a corresponding point of the model, and then to deliver a message representing the belonging, or not, of the said primary information values to the said ranges;

it is possible to determine a variation in difference or differences and surface area between primary information spaced apart in time and a chosen model, and to deduce future primary information from this variation.

The invention can be implemented in any type of communication network, private or public, and in particular in the Internet (IP), ATM and Frame Relay networks. Moreover, the invention can permit the controlling of many services, and in particular IP VPN, high rate, web services, multimedia and 3G.

Other characteristics and advantages of the invention will emerge from an examination of the following detailed description and the accompanying drawings, in which:

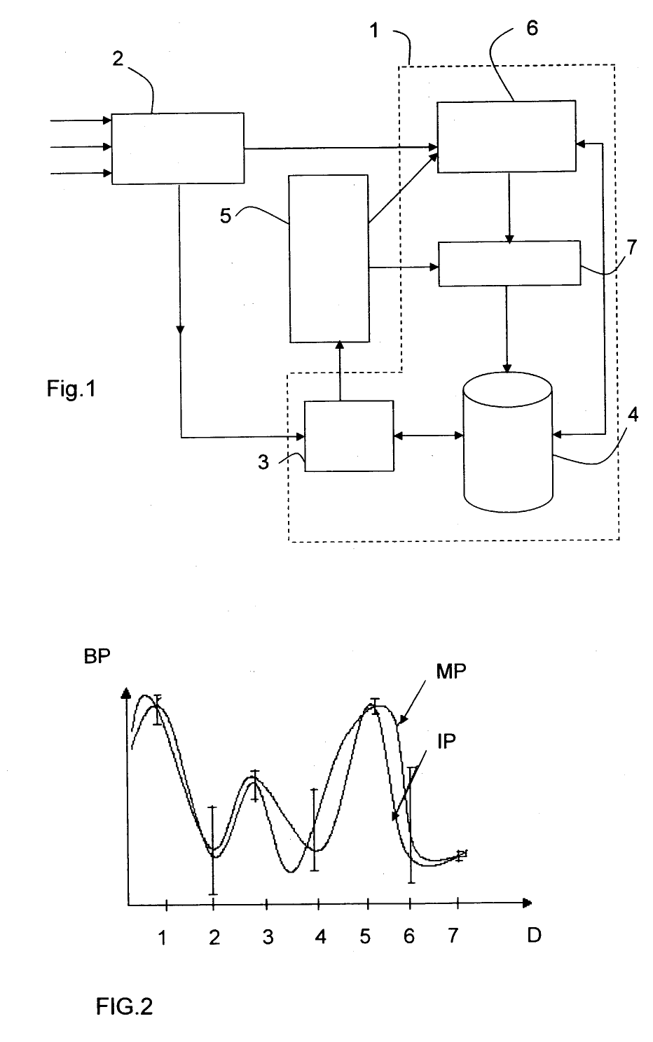

FIG. 1 illustrates schematically an example embodiment of a device according to the invention,

FIG. 2 is a comparative diagram illustrating the phase of identifying a profile of the bandwidth used (IP) with a model (MP),

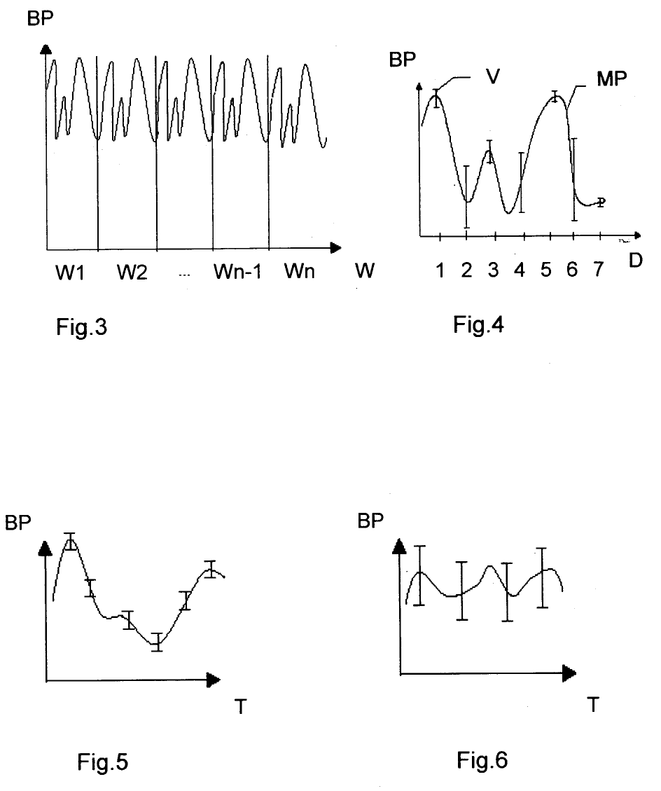

FIG. 3 is a diagram illustrating profiles of bandwidths used (BP) corresponding to successive weeks (Wi),

FIG. 4 is a diagram illustrating the mean weekly profile resulting from the weekly bandwidth profiles of FIG. 3, according to the days of the week, and the variances (V) associated with characteristic points of this mean profile,

FIG. 5 is a diagram illustrating a first profile of a bandwidth used, according to the days of the week; this profile constituting an invariant able to define a model,

FIG. 6 is a diagram illustrating a second profile of a measured bandwidth, according to the days of the week; this profile not constituting an invariant able to define a model.

These drawings are essentially certain in nature. Consequently they can not only serve to supplement the invention but also contribute to its definition, where applicable.

The device according to the invention is intended to be installed at the heart of a communications network so as to monitor the data, referred to as primary data, which are exchanged by the terminals, in particular customer terminals, connected to the said network. By way of non-limiting example, it is considered hereinafter that the network is the Internet public network in which the data are exchanged according to the IP protocol. However, it could be a case of a private network, of the Intranet type, or several public and/or private networks connected to one another. Moreover, it is considered hereinafter that at least some of the network customers have made with the operator service level agreements (or SLAs) which include technical parts defined by service level specifications (or SLSs).

Preferentially, the device 1 is located in a server (not shown) controlled by the network operator, and more precisely by the manager of this network.

The device 1 illustrated in FIG. 1 is supplied with primary information, representing the primary data exchanged by the various terminals and equipment in the network. “Primary information” means here information data, such as service data, delivered by modules making measurements of all kinds on the primary data, for example measurements of bandwidth used or measurements of flow, measurements of packet losses, measurements of delays between packets, measurements of jitter or stability, and measurements of bandwidth stability. Some of these measurements therefore represent the performance of the network, or at least part of this. However, it is also possible to take account of other types of parameter, such as for example those resulting from formulae defining for example the stability of the bandwidth or changes in the stability, or the reliability or directionality of a communication, or the like. It is also possible to use extrapolated parameters, such as for example parameter trends. Yet other primary information can be taken into account, such as for example alarms emitted by equipment in the network such as the routers and interfaces. In general terms, it is possible to take account of all the data going back from the network, as well as those determined or extrapolated by calculation. Moreover, this primary information can represent either measurements made “directly” (or almost instantaneously), or predictive measurements, such as for example the estimation of future changes in the load on the network having regard to prior load measurements.

In the example illustrated, a single measuring module 2 represents all the modules and equipment able to deliver primary information useful to the device 1.

This device 1 comprises first of all a control module 3 supplied with primary information by the measuring module 2 and coupled to a memory 4 in which there are stored secondary data which define models representing primary information.

A model is for example represented by a curve or profile MP of the type illustrated in FIG. 6. It defines for example the typical (usual) change in a parameter of the network, such as the bandwidth BP used, or service data, over a chosen interval of time and/or over a chosen period, such as for example a day, a week, a month or a quarter. The example in FIG. 6 illustrates the typical change in the bandwidth used, day (D) after day, over a period of one week (W). As will be seen later, a model MP of the type illustrated is generally associated with a few statistical values representing the typical scattering of the associated measured value. This statistical value is for example the variance V.

The control module 3 is intended to compare, in real time, the primary information which it receives with at least one of the models stored (in fact the one which corresponds to their type) in order to inform the network manager of normal or abnormal functioning. More precisely, when the control module 3 receives primary information, it determines the type thereof, and possibly the associated time window, and then extracts from the memory 4 the model which corresponds to this type. Naturally, it is also possible to envisage that the extraction of a model results from an instruction sent, for example, by the network manager and designating the said model.

When the primary information is substantially identical to the model which corresponds to it, then the control module considers that there is identification between the said model and the said primary information, or in other words that the functioning of the equipment or services to which the said primary information relates is normal (or usual). It then delivers a message indicating that there has been identification.

On the other hand, when the primary information differs appreciably from the model which corresponds to it and with which it is confronted, then the control module 3 considers that there is not identification between the said model and the said primary information, or in other words that the functioning of the equipment or services to which the said primary information relates is abnormal (or unusual). It then delivers a message (alarm message) indicating that there has not been identification.

The messages delivered therefore represent the correlation (or identification) level between the primary information received and the secondary data which define the model stored which corresponds thereto.

Many techniques can be envisaged for deciding on identification or non-identification. As illustrated in FIG. 2, it is in fact a case of comparing two curves or profiles, for example one (MP) representing a model, the other (IP) representing primary information received. Naturally, the graphical representation in the form of curves is given only to facilitate understanding of the processing carried out. In practice, it is files of values which are compared.

A first method may consist in calculating for a certain number of points representing primary information, or even all, if their value is contained in a range associated with the value of the corresponding point of the model. This range, which is delimited by thresholds (upper and lower), can advantageously be defined by the variance V, when this is attached to the model stored. If a point representing the primary information is contained in the corresponding range, then there is local identification. In the contrary case (“passing of the threshold”), there is no local identification. The global identification to the model of all the points representing the primary information can be accepted by the control module 3 either when all the points have been the subject of local identification or when a limited number of points (chosen for example so as to be equal to 2 or 3) have not been the subject of local identification.

A second method can consist in calculating the surface (or area) included between the curves representing respectively the primary information delivered and the corresponding model, and then determining whether this surface area is included in a range delimited by thresholds (upper and lower) and attached to the stored model. If the value of the surface area is contained in the corresponding range, then there is global identification. In the contrary case (“passing of threshold”), there is no global identification.

Naturally other comparison (or identification) techniques can be envisaged, such as for example the calculation of the statistical distance. It is also possible to envisage combining several techniques, notably in order to increase the precision or reliability of the identification.

Preferentially, the messages are communicated by the control module 3 to a graphical interface 5 of the server, for example of the GUI (standing for “Graphical User Interface”) type. These messages can be accompanied by an identification diagram of the type illustrated in FIG. 2, in particular when there has not been global identification, and/or by ancillary information data associated in advance with the model, for example by the network manager. The ancillary data correspond, for example, to a text identifying a recognised profile. In this case, the network manager associates the message which seems to him to be most appropriate. These messages can for example be: “Conventional Monday recognised”, “Whit Monday recognised”, “Conventional week recognised” (for example in the case of five consecutive working days with a normal characteristic load distribution), “week with public holiday recognised”, “Conventional month not recognised”, “Month with holidays recognised”, “Profile corresponding to recognised saturation”, etc.

The control module 3 can also be arranged so as to carry out the predictions of changes in primary information by means of an analysis of the changes (or variations) in the differences in deviations or surface area between the primary information, successively received and analysed, and the corresponding module. In this case, the control module 3 delivers to the graphical interface 5 a message representing the predicted change (or trend), so that the manager can have available analyses by identification, corresponding to primary information which might subsequently be unavailable or not measurable. This may also make it possible to anticipate any problem.

In addition, the control module 3 can be arranged so as to compare primary information received with several different models associated with different situations, such as for example periods of work or periods of holiday. It is in fact possible to envisage that, in the absence of identification with a first model, the control module 3 extracts a second model and attempts a second identification. If no model corresponds to the primary information received, the message generates the signal to the manager, who will then have to seek the cause of the abnormality in functioning detected. On the other hand, if one of the models corresponds to the primary information received, the message generated can directly indicate to the manager the cause of the abnormality in functioning detected.

The device according to the invention also preferably comprises a processing module 6 coupled to a modelling module 7.

The processing module 6 is first of all intended to receive the primary information delivered by the measuring module 2 and store it in the memory 4, as it arrives, preferably in correspondence with chosen time windows. This windowing can relate to durations of around one minute, one hour, one day, one week, one month, one quarter or one year, according to the requirements of the network manager.

Once the primary information has been associated with a time window, the processing module 6 can compare it, preferably in real time, with at least some of the primary information previously stored in the memory 4, with reference to this same time window, so as to detect any invariance (or similarity) in behaviour of the primary information delivered and stored, of the same type. It is a case in fact of determining whether all this primary information of the same type, and associated with the same time window, can define a specimen model of normal (or usual) functioning, or in other words to determine whether it is substantially invariant.

For example, the processing module 6 must verify whether the profile of the bandwidth BP used by an LSP (standing for “Label Switch Path”) is invariant each week, or in other words whether this profile is substantially the same from one week to the next.

Many methods can be envisaged for determining any invariant. One method can consist in extracting from the memory 4 the primary information stored, associated with identical but successive time windows. For example, as illustrated in FIG. 3, on reception of a weekly profile of bandwidth BP used, the processing module 6 extracts the weekly profiles of the bandwidth BP used from the 49 previous weeks (W1 to W(n−1), n being here equal to 50). Then it effects the mean of these fifty profiles, which supplies secondary information defining a mean profile associated with the time window chosen (here one week), as illustrated in FIG. 4.

Preferably the processing module 6 next determines, from the secondary information which defines the mean profile MP, tertiary information representing distributions of the values of certain particular points of the mean profile IP. This tertiary information can for example be variances V each associated with a daily measurement chosen (for example at midday), as illustrated in FIGS. 4 to 6. The variance V (or distribution) of the chosen points of the profile IP is then compared with one or more chosen thresholds. In a variant, it is possible to compare the sum of the variances with a chosen threshold.

If a chosen number of variances (or the sum of the variances) is less than the threshold, then the processing module 6 considers that the mean profile IP is invariant. This chosen number can be equal to the total number of variances calculated, or to the total number minus one or two variances, for example. This first situation (of invariance) is illustrated in FIG. 5. On the other hand, if a chosen number of variances (or the sum of the variances) is greater than the threshold, then the processing module 6 considers that the mean profile IP is not invariant. This chosen number can be equal to one or two, for example. This second situation (of non-invariance) is illustrated in FIG. 6.

The modelling module 7 is, in the event of detection of an invariance by the processing module 6, intended to generate a model MP representing the primary or secondary information and to store it in the memory 4.

Many techniques can be envisaged for generating models. A first technique can consist in defining a model MP from all the secondary information defining, for example, a mean profile IP. In this case, all the secondary information determined by the processing module 6 is stored in the form of secondary data in the memory 4.

A second technique may consist in defining a model MP from a mathematical processing, such as a polynomial regression, applied to the secondary information determined by the processing module 6. In this case the parameters representing the result of the mathematical processing, which then define the model MP, are stored in the memory 4 in the form of secondary data.

Other modelling techniques can be envisaged, and in particular the parametric technique. This consists in modelling curves by means of parametric equations and storing only the parameters of the equations. In general terms, all the techniques allowing the modelling of a profile (curve), within the meaning defined above, can be used.

In order not to overload the memory 4, it is preferable for the modelling module 7 to compare each new model MP generated with the models stored before deciding on its storage. In this way, only the models actually different from the old models are stored.

It is important to note that the processing 6 and modelling 7 modules are merely elements which are complementary to the control module 3 of the device. It can in fact be envisaged that all the models MP be supplied by the network manager, for example via the graphical interface 5. It is also possible to envisage a mixed variant in which some of the models are generated by the device and others supplied by the network manager, via the graphical interface 5.

Moreover, some models can be stored in the memory 4 accompanied by ancillary information, of the type presented above, and for example intended to constitute at least some of the message delivered. In this case, when the device is arranged so as to generate at least some of the models, the modelling module 7 proceeds with the storage of a new model only after having obtained the authorisation of the network manager, accompanied by any ancillary information.

The control 3, processing 6 and modelling 7 modules of the device can respectively be produced in the form of electronic circuits, software (or computer) modules, or a combination of circuits and software.

Moreover, in the above a control module 3 was described which was directly supplied with primary information by the measuring module 2. However, the control module 3 could be supplied with primary information by the processing module 6.

The invention also offers a method for controlling primary data within a communication network, in which primary information representing primary data is delivered. This can be implemented by means of the device presented above. The principal and optional functions and subfunctions provided by the steps of this method being substantially identical to those provided by the various means constituting the device, only the steps implementing the principal functions of the method according to the invention will be summarised below.

This method consists in storing, in a memory 4, secondary data which define models MP representing primary information, and comparing primary information with at least one of the models, so as to deliver a message representing a correlation (or identification) level between this primary information and the model chosen.

The method can also comprise a phase of generating models from the primary information received. This phase consists, for example, in storing in the memory 4 the primary information delivered in correspondence with chosen time windows, and then comparing the primary information delivered, associated with a chosen time window, with at least some of the primary information stored, associated with this chosen time window, so as to determine any invariance between the primary information delivered and stored and, in the event of detection of an invariance, generating a model representing the primary information and storing this model in the memory.

The method can also comprise a phase in which the variations in difference or differences and/or surface area between primary information spaced apart in time and a chosen model are determined, so as to deduce from this variation future primary information.

By virtue of the invention, it is now possible to partially or completely automate, directly and if necessary permanently, the phase of identification or correlation of the primary information with chosen models, and possibly the model generation phase. This enables the network operator to concentrate on the controlling of the network and in particular on the resolution of any problems which arise in this network or which are liable to arise.

In addition, this makes it possible to detect trends by confronting the primary information with several different models associated with different situations, such as for example periods of work or periods of holiday.

In addition, the invention applies to a great variety of data exchange networks, and in particular the IP, ATM and Frame Relay networks, and to many types of service, and in particular IP VPN, high rate (for example ADSL access), web services, multimedia and 3G.

The invention can be used in many applications, such as for example the planning and configuration of a network, controlling of SLAs (“Service Level Agreements”)/SLSs (“Service Level Specifications”), or diagnosis. The invention can in particular make it possible to inform an operator that an LSP (“Label Switch Path”) is saturated or underused, so that he allocates more or less bandwidth to the LSP concerned. It can also make it possible to inform an operator that his network has abnormal functioning, for example because the profile of the current week does not correspond to the specimen profile of a conventional week.

The invention is not limited to the embodiments of the methods and devices described above, solely by way of example, but encompasses all variants which might be envisaged by a person skilled in the art in the context of the following claims.

What is claimed is:

1. A device for controlling primary data in a communications network comprising measuring means (2) able to deliver primary information representing primary data, characterised in that it comprises a memory (4) in which there are stored secondary data defining models representing primary information, and control means (3) arranged to compare the said primary information delivered by the measuring means to at least one of the said models so as to deliver a message representing a correlation level between this primary information and the said model.

2. A device according to claim 1, characterised in that the said memory (4) stores models representing changes in primary data flows on chosen time windows.

3. A device according to claim 1, characterised in that it comprises i) processing means (6) intended to receive the said primary information and store it in the memory (4) in correspondence with chosen time windows, and to compare the said primary information delivered, associated with a chosen time window, with at least some of the said primary information stored, associated with this chosen time window, so as to determine any invariance between the said primary information delivered and stored, and ii) modelling means (7) arranged, in the event of determination of an invariance, to generate a model representing the said primary information and store the said model in the said memory (4).

4. A device according to claim 3, characterised in that the said processing means (6) are arranged to extract from the said memory (4) certain primary information stored, associated with the same chosen time window, and then to generate secondary information representing this averaged primary information, and to determine any invariance according to at least the said secondary information.

5. A device according to claim 4, characterised in that the said processing means (6) are arranged to determine tertiary information representing distributions of the values of certain secondary information, and to compare the said tertiary information with first thresholds, so as to determine any invariance in the said primary information delivered and stored.

6. A device according to claim 4, characterised in that at least some of the models generated are defined from all the corresponding secondary information, the said secondary information defining the said model then being stored in the said memory (4).

7. A device according to claim 4, characterised in that the said modelling means (7) are arranged to generate at least some of the models from a mathematical processing applied to the said corresponding secondary information, the parameters representing the result of the said mathematical processing, and defining the said model, then being stored in the said memory (4).

8. A device according to claim 3, characterised in that the said modelling means (7) are arranged to compare each new model generated with the said models stored, so as to store a new model only when it is different from the models already stored.

9. A device according to claim 1, characterised in that the said memory (4) is coupled to a user interface (5) so as to be supplied with models.

10. A device according to claim 1, characterised in that some models are associated with ancillary information, intended to constitute at least part of the said message delivered.

11. A device according to claim 1, characterised in that the said control means (3) are arranged so as to i) extract from the said memory (4) a chosen model, ii) to determine the difference between at least one of the values defining the said primary information and the corresponding value associated with the said model extracted, and iii) to deliver a message representing the said difference.

12. A device according to claim 1, characterised in that the said control means (3) are arranged to constitute curves from primary information and models, and to determine the surface area included between a first curve representing primary information delivered and a second curve representing an extracted model, so as to deliver a message representing the value of the said surface area.

13. A device according to claim 11, characterised in that the said control means (3) are arranged to determine whether at least some of the primary information delivered has a value contained in a range associated with the value of a corresponding point of the model, and to deliver a message representing the belonging, or not, of the said values of the primary information to the said ranges.

14. A device according to claim 11, characterised in that the said control means (3) are arranged so as to determine a variation in difference or differences or surface area between primary information spaced apart in time and a chosen model, and to deduce future primary information from this variation.

15. A method for controlling primary data within a communication network, in which primary information representing primary data is delivered, characterised in that it consists in storing in a memory (4) secondary data defining models representing primary information, and comparing the said primary information delivered with at least one of the said models so as to deliver a message representing a level of correlation between this primary information and the said model.

16. A method according to claim 15, characterised in that the said models represent changes in primary data flows on chosen time windows.

17. A method according to claim 15, characterised in that there is stored in the memory (4) the primary information delivered in correspondence with chosen time windows and then the primary information delivered, associated with a chosen time window, is compared with at least some of the said primary information stored, associated with this chosen time window, so as to determine any invariance between the said primary information delivered and stored and, in the event of determination of invariance, to generate a model representing the said primary information and store the said model in the said memory (4).

18. A method according to claim 17, characterised in that certain primary information stored, associated with the same chosen time window, is extracted from the memory (4), and then secondary information representing this averaged primary information is generated, and any invariance is determined according to at least the said secondary information.

19. A method according to claim 18, characterised in that tertiary information representing distributions of the values of certain secondary information is determined, and the said tertiary information is compared with first thresholds, so as to determine any invariance in the said primary information delivered and stored.

20. A method according to claim 18, characterised in that at least some of the models generated may be defined using all the corresponding secondary information, the said secondary information defining the model being then stored in the memory (4).

21. A method according to claim 18, characterised in that at least some of the models are generated from a mathematical processing applied to the said corresponding secondary information, the parameters representing the result of the said mathematical processing, and defining the said model, then being stored in the said memory (4).

22. A method according to claim 17, characterised in that each new model generated is compared with the said models stored, so as to store a new model only when it is different from the models already stored.

23. A method according to claim 17, characterised in that some models are supplied by an operator.

24. A method according to claim 15, characterised in that some models are associated with ancillary information intended to constitute at least part of the said message delivered.

25. A method according to claim 15, characterised in that, on reception of primary information, a chosen model is extracted from the memory (4), and then the difference between at least one of the values defining the said primary information and the corresponding value associated with the said extracted model is determined, and a message representing the said difference is delivered.

26. A method according to claim 15, characterised in that curves are constituted from the primary information and models, and the surface area included between a first curve representing primary information delivered and a second curve representing a model extracted is determined, so as to deliver a message representing the value of the said surface area.

27. A method according to claim 15, characterised in that it is determined whether at least some of the primary information delivered has a value contained in a range associated with the value of a corresponding point of the model, and a message representing the belonging, or not, of the said values of the primary information to the said ranges is delivered.

28. A method according to claim 15, characterised in that a variation in difference or differences or surface area between primary information spaced apart in time and a chosen model is determined, and future primary information is deduced from this variation.

29. Use of the methods and devices according to one of the preceding claims in the networks chosen from amongst public and private networks.

30. Use according to claim 29, characterised in that the network is chosen from a group comprising the Internet (IP), ATM and Frame Relay networks.

31. Use according to claim 29, for controlling services chosen from a group comprising at least IP VPN, high rate, web services, multimedia and 3G.
